(19) United States
(12) Patent Application Publication
(10) Pub. No.: US 2026/0312970 A1
(43) Pub. Date: Oct. 8, 2026

(54) Platform-Agnostic AI-Generated Token System for Network Resiliency

(71) Applicant: Bank of America Corporation, Charlotte, NC (US)

(72) Inventors: Adam King, Fort Mill, SC (US); Naga Vamsi Krishna Akkapeddi, Charlotte, NC (US); Julie Stanley, Indian Land, SC (US); Peter Nein, Waxhaw, NC (US); Brittney K. Spencer, Fort Mill, SC (US); Erica Finigan, Charlotte, NC (US); Jeremy James Arel, Fort Mill, SC (US); Tori Mitcheson, Fort Mill, SC (US); Sanjay Lohar, Mint Hill, NC (US); James Siekman, Charlotte, NC (US); Matthew Bryant, Mt. Holly, NC (US)

(21) Appl. No.: 19/171,587

(22) Filed: Apr. 7, 2025

(51) Int. Cl. H04L 9/40; H04L 9/32

(52) U.S. Cl. CPC H04L 63/1425; H04L 9/3213; H04L 63/0263

(57) ABSTRACT

A system and method enhance network resiliency across applications using a cluster of AI models trained on network functions like authentication, authorization, data validation, traffic filtering, load balancing, and encryption offloading. A network monitoring system tracks application health metrics, detecting failures against predefined thresholds. Upon failure, a generative AI creates a platform-agnostic token with metadata specifying the function, application features, and protocol, encrypted for security. An event bus distributes the token to backup applications, selecting the first responder via acceptance signals. A gateway updates routing policies, redirecting traffic seamlessly. Unique features include federated learning for privacy-preserving AI refinement, dynamic threshold adjustments, composite tokens for multi-function failures, and microservices deployment across edge and cloud environments, ensuring interoperability and scalability in diverse ecosystems.

### TECHNICAL FIELD

The inventions disclosed herein pertain to systems and methods for enhancing network resiliency through adaptive, platform-independent mechanisms, encompassing the design and implementation of data processing systems that manage and coordinate network functions across distributed environments. These inventions involve the use of artificial intelligence to generate dynamic tokens that facilitate seamless communication and failover between applications, aligning with technologies focused on data processing and network management. Additionally, the inventions address real-time monitoring and automated policy updates within networked systems, contributing to advancements in the architecture and operation of communication networks. This includes the integration of event-driven frameworks and gateway configurations to ensure uninterrupted data flow and system reliability across diverse platforms.

### DESCRIPTION OF THE RELATED ART

The inventions disclosed herein address a pervasive issue in modern application ecosystems where platform-specific policies govern essential network functions such as authentication, authorization, data validation, traffic filtering, load balancing, and encryption offloading. In these ecosystems, each application generates and enforces its own set of rules tailored to its operational environment. This individuality creates isolated silos, meaning that when one application experiences a failure, other applications, even those designed as backups, cannot step in to assume its responsibilities. The root of this problem lies in the lack of a common framework that allows applications to interpret and adopt the policies of a failing application, resulting in significant operational disruptions.

When an application fails, the inability of backup applications to take over stems from discrepancies in authentication and authorization mechanisms. Each application may employ distinct security protocols, such as differing identity providers or token formats, which are not inherently compatible across platforms. Without a shared understanding of these security policies, a backup application cannot verify user credentials or permissions in the same manner as the original, leading to authentication gaps. This incompatibility prevents a smooth transition of operations, causing delays or complete halts in transaction processing as systems struggle to reconcile these differences.

Traffic filtering presents another layer of complexity in this scenario. Applications often rely on gateways to direct network traffic based on predefined protocols, such as HTTP or FTP. However, when policies are tied to a specific application, a backup application may not support the same protocol or filtering rules. This mismatch results in traffic filtering incompatibility, where the gateway cannot route requests appropriately to a substitute application. Consequently, network traffic either stalls or is misdirected, exacerbating service interruptions and undermining the reliability of the ecosystem.

Load balancing further compounds these challenges when applications operate in isolation. In a typical setup, multiple nodes or applications share workloads to prevent any single point from becoming overwhelmed. Yet, if a primary application fails and its policies are not transferable, the load balancing system cannot redistribute traffic to backup applications. This breakdown occurs because the backup applications lack the configuration details needed to handle the incoming load, leading to uneven distribution. Nodes that remain operational may become overloaded, while others sit idle, creating inefficiencies and potential points of failure within the network.

Encryption offloading introduces additional complications in this siloed environment. Many systems dedicate specific servers to handle encryption tasks, offloading this resource-intensive process from primary application nodes. When an application fails, its backup must decrypt and process traffic using the same encryption keys and methods. Without access to the original application's encryption policies, the backup server cannot perform this task, rendering it unable to handle encrypted data streams. This failure disrupts secure communication channels, leaving transactions vulnerable or incomplete as the system cannot maintain confidentiality and integrity.

Inconsistent logging and monitoring practices across applications also hinder effective troubleshooting and recovery. Each application may generate logs in a unique format or level of detail, such as verbose debug entries versus minimal error reports. When a failure occurs, this fragmentation makes it difficult to piece together a cohesive picture of the event across the ecosystem. Teams tasked with diagnosing the issue face delays as they sift through disparate log files, slowing down the identification of root causes and prolonging downtime. This lack of uniformity in observability tools amplifies the impact of any single application failure.

The absence of interoperability among applications creates network bottlenecks that ripple through the system. As traffic cannot flow seamlessly to backup applications, queues build up at gateways or overloaded nodes, increasing latency and degrading performance. Users experience sluggish response times or outright service unavailability, which can disrupt business operations or end-user interactions. These bottlenecks highlight how tightly coupled application-specific policies limit the flexibility and resilience of the network as a whole.

Transaction failures emerge as a direct consequence of these interoperability issues. When authentication falters, traffic misroutes, or encryption breaks down, transactions in progress—such as data transfers or user requests—cannot complete. This leads to data loss, repeated attempts to reprocess requests, or manual intervention to restore functionality. In high-stakes environments where reliability is paramount, such failures erode trust in the system and incur significant operational costs as resources are diverted to address the fallout.

Service disruptions represent the culmination of these problems, as the network cannot maintain continuity in the face of application failure. Even when backup applications exist and are functional, their inability to adopt the failing application's role means that services grind to a halt. This downtime affects not only the immediate application but also interconnected systems that rely on its output, creating a domino effect across the ecosystem. The lack of a unified approach to policy management leaves the network vulnerable to cascading failures, amplifying the scope and severity of each incident.

These challenges reflect a long felt and unmet need for a solution that bridges the gap between disparate application platforms. For years, networked systems have grappled with the limitations of platform-specific policies, seeking a way to ensure resilience without sacrificing operational efficiency. Existing approaches, such as manual policy replication or rigid standardization, have proven inadequate, either requiring excessive human oversight or failing to adapt to diverse environments. The persistent recurrence of bottlenecks, transaction failures, and service disruptions underscores the demand for an automated, flexible mechanism that enables seamless failover and maintains network integrity across heterogeneous applications.

### SUMMARY OF THE INVENTION

The inventions disclosed herein introduce sophisticated systems and methods designed to enhance network resiliency through a platform-agnostic, artificial intelligence-driven tokenization approach. This system addresses the need for seamless application failover across diverse ecosystems by creating a unified mechanism that transcends the limitations of application-specific policies. At its core, the invention leverages a cluster of artificial intelligence models, each trained to manage distinct network functions such as authentication, authorization, data validation, traffic filtering, load balancing, and encryption offloading. These models collectively ensure that network operations remain uninterrupted even when individual applications falter.

A key component of this invention is the cluster of artificial intelligence models, which operate using advanced frameworks like TensorFlow, PyTorch, and fine-tuned models from OpenAI. Each model within the cluster focuses on a specific network function, gaining a deep understanding of application features, backup capabilities, and preferred communication protocols. Deployed in a redundant configuration, these models function in an active-passive setup, meaning that standby models can assume control if the primary ones encounter issues. This redundancy ensures that the system remains operational, providing continuous policy generation and coordination across the network.

The invention incorporates a network monitoring system that plays a pivotal role in maintaining ecosystem stability. Utilizing tools such as Prometheus for real-time monitoring, Grafana for visualization, and the ELK stack (Elasticsearch, Logstash, Kibana) for log aggregation, this system tracks the health of applications across both edge and cloud environments. It measures parameters like CPU usage, memory consumption, and error rates, comparing them against predefined threshold values tailored to each application type. When an application's performance dips below its designated threshold, the monitoring system activates the artificial intelligence cluster to initiate a response, ensuring timely intervention.

Another integral element is the generative artificial intelligence module responsible for token creation. This module relies on Python-based libraries, such as PyJWT for token generation and HashiCorp Vault for secure storage, to produce platform-agnostic tokens. These tokens encapsulate metadata specific to the network function in question, including application features, communication protocols, and encryption keys. Following the RFC 7519 JSON Web Token standard, the schema includes custom fields to enable compatibility across diverse platforms. The tokens are signed and encrypted before distribution, ensuring security and integrity as they circulate through the system.

The process of token distribution is facilitated by an event bus, a mechanism that underpins the invention's event-driven architecture. Technologies like Kafka, RabbitMQ, or Google Pub/Sub power this component, enabling low-latency propagation of tokens across the network. Once generated, the artificial intelligence cluster broadcasts these tokens via the event bus, where backup applications subscribed to the system receive them. Each backup application evaluates its capacity to fulfill the requested network function and responds with an acceptance signal if capable, allowing the system to select the first available candidate to assume the role.

Dynamic gateway policy updates represent a further advancement in this invention, ensuring that network traffic flows seamlessly to the designated backup application. This component employs tools such as Envoy Proxy, HAProxy, or Istio within a service mesh framework to manage traffic routing. Upon receiving an acceptance signal from a backup application, the gateway automatically updates its routing policies via API calls, modifying YAML-based configurations to redirect traffic. This automation eliminates the need for manual intervention, maintaining continuity and minimizing downtime during failover events.

The invention's platform-agnostic tokenization sets it apart by enabling interoperability across heterogeneous application environments. Unlike traditional systems that rely on static, application-specific policies, this approach generates dynamic tokens that any compatible application can interpret, regardless of its underlying technology. This universality allows backup applications running different identity providers, such as Okta or Azure AD, to handle tasks like OAuth 2.0 transactions without requiring extensive reconfiguration, broadening the system's applicability.

The use of generative artificial intelligence for custom token creation introduces a layer of adaptability to the invention. Rather than adhering to predefined policy templates, the system tailors tokens in real time based on the specific needs of the ecosystem and the capabilities of available backup applications. This flexibility ensures that the tokens align with the features and protocols of the application stepping in, optimizing performance and compatibility during failover scenarios.

The event-driven architecture, powered by the event bus, enhances the invention's responsiveness. By broadcasting tokens and awaiting acceptance signals, the system decentralizes the decision-making process, allowing backup applications to self-select based on their readiness. This rapid distribution and acceptance mechanism reduces latency, ensuring that traffic redirection occurs swiftly and efficiently, a stark contrast to manual or centralized failover methods.

Dynamic gateway updates further streamline the failover process by automating traffic rerouting. When a backup application accepts a token, the gateway reconfigures itself without human input, directing traffic to the new application seamlessly. This capability is particularly valuable in scenarios where an application handling HTTPS traffic filtering fails, as the system can transition responsibilities to a backup without disrupting secure connections.

The invention also incorporates privacy-preserving techniques through federated learning, a method that refines the artificial intelligence models without compromising sensitive data. This approach allows the models to improve their token generation accuracy by learning from distributed datasets across platforms, while masking data elements to maintain confidentiality. This feature ensures that the system evolves over time without exposing proprietary or user-specific information.

A practical example of the invention's operation involves an application responsible for data validation reaching its failure threshold. The network monitoring system detects this decline and triggers the artificial intelligence cluster, which identifies a suitable backup application. The generative artificial intelligence module then creates a token embedding the necessary policies for data validation, broadcasting it via the event bus. A backup application signals its readiness, and the gateway updates its routing policy to redirect traffic, restoring functionality without interruption.

Another scenario might involve an application managing HTTPS traffic filtering. Upon failure, the monitoring system activates the artificial intelligence cluster, which generates a token compatible with backup applications supporting the same protocol. The event bus distributes this token, and the first accepting application takes over, with the gateway adjusting traffic flow accordingly. This process ensures that secure communication persists across the network.

The invention's reliance on a cluster of specialized artificial intelligence models provides a robust foundation for handling diverse network functions. Each model's training on specific tasks, such as load balancing or authentication, allows for precise policy generation tailored to the context of the failure. This specialization enhances the system's ability to address multifaceted challenges within the ecosystem.

The integration of real-time monitoring with automated token generation and distribution creates a proactive rather than reactive system. By continuously assessing application health and responding at predefined thresholds, the invention preempts disruptions, initiating failover procedures before complete failure occurs. This forward-looking design distinguishes it from traditional systems that address issues only after they manifest.

The use of widely adopted technologies, such as Prometheus, Kafka, and Envoy Proxy, ensures that the invention can be implemented within existing infrastructures. These tools provide a familiar framework for deployment, reducing the learning curve for adoption while leveraging established reliability. Containerized microservices further enhance scalability, allowing the system to operate across edge and cloud environments seamlessly.

The invention's ability to handle multiple backup applications simultaneously adds a layer of resilience. When a token is broadcast, several applications may signal readiness, enabling the system to choose the most suitable candidate based on availability or performance metrics. This multiplicity reduces the risk of a single point of failure within the failover process itself.

The token schema's adherence to the JSON Web Token standard, augmented with custom fields, balances standardization with flexibility. This design choice ensures compatibility with existing security frameworks while accommodating the unique requirements of platform-agnostic communication. The result is a system that integrates with diverse applications without necessitating extensive modifications.

The invention's decentralized approach, driven by the event bus and acceptance signals, eliminates bottlenecks associated with centralized control. By distributing decision-making to the applications themselves, the system achieves faster response times and greater scalability, adapting to the size and complexity of the network. This decentralization aligns with modern distributed computing principles, enhancing its relevance in contemporary ecosystems.

In light of the preceding discussion, the following identifies various sample embodiments of the present disclosure to establish a basic understanding of its various components. This summary is not exhaustive, nor does it limit the illustrative embodiments of the inventions described in this document. It is not intended to identify the most essential features or steps of the disclosure, nor to define its scope. Instead, as would be recognized by someone skilled in the field, it seeks to introduce certain concepts of the disclosure in a clear and simple way, acting as a preface to the more detailed explanation that follows. Throughout this application, the specification offers thorough written descriptions of the inventions, including exemplary, non-exhaustive, and non-limiting methods and processes for making and using the inventions. These descriptions are expressed in complete, clear, concise, and precise terms, allowing those skilled in the art to implement and utilize the inventions without undue experimentation, while also indicating the preferred method envisioned for carrying out the inventions.

In some arrangements, a method enhances network resiliency across a plurality of applications by employing several coordinated steps. A cluster of artificial intelligence models trains each model on a distinct network function from a set including authentication, authorization, data validation, traffic filtering, load balancing, and encryption offloading, with each model configured to generate policies based on application features and communication protocols. A network monitoring system monitors health metrics of each application in the plurality, where these metrics encompass processor usage, memory consumption, and error rates.

In some arrangements, the network monitoring system detects when the health metrics of a first application in the plurality fall below a predefined threshold. Upon this detection, a generative artificial intelligence generates a platform-agnostic token for the first application, where the token includes metadata specifying a network function from the set, application features of the first application, and a communication protocol. An event bus distributes this platform-agnostic token to a set of backup applications within the plurality, and subsequently receives an acceptance signal from a second application in the set indicating readiness to perform the specified network function.

In some arrangements, a gateway updates a routing policy to redirect network traffic from the first application to the second application based on the platform-agnostic token. The gateway then redirects the network traffic to the second application using the updated routing policy, completing the failover process to maintain network continuity.

In some arrangements, the method includes training each model in the cluster of artificial intelligence models using a dataset comprising historical application performance data and protocol specifications. This training enhances the models'ability to generate accurate policies tailored to the applications'operational contexts.

In some arrangements, monitoring the health metrics of each application in the plurality involves aggregating logs using a log aggregation tool and visualizing the health metrics via a graphical interface. This approach provides a comprehensive and accessible overview of application performance across the ecosystem.

In some arrangements, detecting when the health metrics of the first application fall below the predefined threshold involves comparing the health metrics against a threshold value customized for the first application based on its operational requirements. This customization ensures that detection aligns with the specific needs of each application.

In some arrangements, generating the platform-agnostic token includes encrypting the token with an encryption key stored in a secure vault. This encryption step secures the token against unauthorized access during its generation and distribution.

In some arrangements, distributing the platform-agnostic token to the set of backup applications involves broadcasting the token across a distributed messaging system configured to handle high-throughput communication. This system ensures efficient and rapid delivery to potential backup applications.

In some arrangements, receiving the acceptance signal from the second application involves selecting the second application as a first responder from multiple acceptance signals received within a predefined timeout period. This selection process prioritizes swift assignment to maintain network responsiveness.

In some arrangements, updating the routing policy includes modifying a configuration file of the gateway via an application programming interface call. This automated modification streamlines the redirection process without manual intervention.

In some arrangements, redirecting the network traffic to the second application includes validating the second application's performance post-redirection using the network monitoring system. This validation confirms the backup application's effectiveness in handling the redirected traffic.

In some arrangements, the method further comprises refining token generation accuracy by the cluster of artificial intelligence models using federated learning across the plurality of applications without exposing application-specific data. This refinement enhances the system's adaptability while preserving privacy.

In some arrangements, a comprehensive method enhances network resiliency across a plurality of applications through an extensive sequence of operations. A cluster of artificial intelligence models trains each model on a distinct network function from a set including authentication, authorization, data validation, traffic filtering, load balancing, and encryption offloading, with each model configured to generate policies based on application features and communication protocols, using a dataset comprising historical application performance data and protocol specifications.

In some arrangements, a network monitoring system monitors health metrics of each application in the plurality, where the metrics include processor usage, memory consumption, and error rates, aggregating logs using a log aggregation tool and visualizing the metrics via a graphical interface. The system detects when the health metrics of a first application fall below a predefined threshold by comparing them against a threshold value customized for the first application based on its operational requirements.

In some arrangements, a generative artificial intelligence generates a platform-agnostic token for the first application upon detection, with the token including metadata specifying a network function, application features of the first application, and a communication protocol, encrypted with an encryption key stored in a secure vault. An event bus distributes the token to a set of backup applications by broadcasting it across a distributed messaging system configured for high-throughput communication, and receives an acceptance signal from a second application, selecting it as the first responder from multiple signals within a predefined timeout period.

In some arrangements, a gateway updates a routing policy to redirect network traffic from the first application to the second application based on the token, modifying a configuration file via an application programming interface call, and redirects the traffic, validating the second application's performance post-redirection using the network monitoring system. The cluster refines token generation accuracy using federated learning across the plurality without exposing application-specific data.

In some arrangements, a container orchestration platform deploys the cluster, monitoring system, event bus, and gateway as microservices across edge and cloud environments. The monitoring system adjusts the predefined threshold dynamically based on real-time network conditions, and the generative artificial intelligence generates a composite token addressing multiple network functions when the health metrics indicate simultaneous degradation across more than one function of the first application.

In some arrangements, a system enhances network resiliency across a plurality of applications with interconnected components. A cluster of artificial intelligence models is configured to train each model on a distinct network function from a set including authentication, authorization, data validation, traffic filtering, load balancing, and encryption offloading, with each model generating policies based on application features and communication protocols.

In some arrangements, a network monitoring system is configured to monitor health metrics of each application in the plurality, including processor usage, memory consumption, and error rates, and to detect when the metrics of a first application fall below a predefined threshold. A generative artificial intelligence is configured to generate a platform-agnostic token for the first application upon detection, with the token specifying a network function, application features, and a communication protocol.

In some arrangements, an event bus is configured to distribute the platform-agnostic token to a set of backup applications and to receive an acceptance signal from a second application indicating readiness to perform the specified network function. A gateway is configured to update a routing policy to redirect network traffic from the first application to the second application based on the token and to redirect the traffic using the updated policy.

In some arrangements, the cluster of artificial intelligence models is further configured to train each model using a dataset comprising historical application performance data and protocol specifications. This training ensures the models produce contextually relevant policies.

In some arrangements, the network monitoring system is further configured to aggregate logs using a log aggregation tool and to visualize the health metrics via a graphical interface. This configuration enhances visibility into application performance trends.

In some arrangements, the network monitoring system is further configured to compare the health metrics against a threshold value customized for the first application based on its operational requirements to detect when the metrics fall below the predefined threshold. This tailored detection improves accuracy in identifying failures.

In some arrangements, the generative artificial intelligence is further configured to encrypt the platform-agnostic token with an encryption key stored in a secure vault. This encryption secures the token throughout its lifecycle.

In some arrangements, the event bus is further configured to broadcast the platform-agnostic token across a distributed messaging system designed to handle high-throughput communication. This design ensures efficient token dissemination to backup applications.

In some arrangements, the event bus is further configured to select the second application as a first responder from multiple acceptance signals received within a predefined timeout period. This selection mechanism optimizes failover speed.

In some arrangements, the gateway is further configured to modify a configuration file via an application programming interface call to update the routing policy. This automation facilitates seamless traffic redirection.

In some arrangements, the cluster of artificial intelligence models is further configured to operate in an active-passive setup where each model has a corresponding backup model ready to assume operations if a primary model fails, and to refine token generation accuracy using federated learning across the plurality of applications without exposing application-specific data. The network monitoring system is further configured to validate the second application's performance post-redirection by analyzing updated health metrics including latency and throughput after the traffic is redirected, and to adjust the predefined threshold dynamically based on real-time network conditions observed across the plurality.

In some arrangements, the generative artificial intelligence is further configured to generate a composite token addressing multiple network functions when the health metrics indicate simultaneous degradation across more than one network function of the first application, with the composite token including additional metadata specifying each affected function. The event bus is further configured to prioritize distribution of the platform-agnostic token to the set of backup applications based on their current operational capacity, and the gateway is further configured to integrate with a container orchestration platform to deploy the system as microservices across edge and cloud environments, ensuring scalability and responsiveness during traffic redirection.

The following description and claims, in conjunction with the drawings—all integral parts of this specification—will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on non-transitory computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification throughout the specification and claims should be interpreted to include their plural counterparts.

### BRIEF DESCRIPTION OF DRAWINGS

FIG. 1 is an exemplary system architecture diagram in accordance with one or more embodiments disclosed herein that illustrates the interconnected components facilitating network resiliency across a plurality of applications. It depicts a sample arrangement of artificial intelligence-driven policy generation, real-time health monitoring, secure token creation, event-driven coordination, and dynamic traffic routing within a distributed and scalable framework.

FIG. 2 is an exemplary flow diagram in accordance with one or more embodiments disclosed herein that illustrates the detailed operational sequence for enhancing network resiliency across a plurality of applications. It outlines a sample process from initializing artificial intelligence model training to managing application failover, performance validation, and system refinement through a series of interconnected decision points and actions.

FIG. 3 is an exemplary sequence diagram in accordance with one or more embodiments disclosed herein that illustrates the dynamic interactions among key actors in the process of enhancing network resiliency across a plurality of applications. It details a sample sequential flow of messages and actions from model training to traffic redirection and system refinement, highlighting the coordination between components.

FIG. 4 is an exemplary class diagram in accordance with one or more embodiments disclosed herein that illustrates the object-oriented structure and relationships among classes pivotal to enhancing network resiliency across a plurality of applications. It details the attributes, methods, and interconnections that define the system's components, providing a blueprint for implementation.

FIG. 5 is a sample combination architecture and flow diagram in accordance with one or more embodiments disclosed herein that illustrates a hybrid integrated structure and operational sequence of a platform-agnostic AI-generated token system for network resiliency. It depicts the interaction of key components like the Cluster of AI Models, Network Monitoring System, Generative AI, Event Bus, and Gateway, alongside the failover process from a primary application to a backup within the Plurality of Applications.

### DETAILED DESCRIPTION

The inventions comprise comprehensive systems and methods crafted to improve network resiliency across a wide range of application ecosystems through an innovative, platform-agnostic, artificial intelligence-driven tokenization strategy. It tackles a significant problem in contemporary network setups where applications function independently due to their reliance on platform-specific policies governing tasks like authentication, authorization, data validation, traffic filtering, load balancing, and encryption offloading. When one application fails, backup applications struggle to assume its duties because they cannot decipher the original app's policies, resulting in network congestion, transaction interruptions, and service outages. The solutions introduce a cohesive framework that guarantees uninterrupted operation by enabling seamless failover, even across diverse technological platforms.

At the core of the system lies a cluster of artificial intelligence models, each carefully trained to handle a distinct network function, such as authentication or traffic filtering. These models, developed using robust tools like TensorFlow, PyTorch, and refined OpenAI frameworks, are equipped to analyze application characteristics, backup capacities, and communication protocols. They are arranged in an active-passive setup to ensure reliability, meaning that if a primary model encounters issues, a backup model steps in immediately, preserving the system's capacity to produce policies on the fly. This built-in redundancy strengthens the system, allowing it to adjust to shifting network conditions while avoiding critical failures within the AI infrastructure.

Complementing this is a network monitoring system that diligently oversees the operational health of all applications in the ecosystem. By employing technologies such as Prometheus for gathering metrics, Grafana for visual representation, and the ELK stack for consolidating logs, it tracks indicators like processor usage, memory consumption, and error frequencies. Each application has tailored threshold values, and when these are breached—perhaps due to excessive latency or rising error rates—the system springs into action. This forward-thinking monitoring approach catches potential issues early, enabling intervention before a total breakdown, which distinguishes it from systems that only react after failures occur.

When a failure is detected, a generative artificial intelligence component steps in to create platform-agnostic tokens. These tokens package essential details, including the specific network function affected, the application's features, and its communication protocol, following the RFC 7519 JSON Web Token standard with added custom fields for broad compatibility. Built with Python libraries like PyJWT and safeguarded by HashiCorp Vault, the tokens are encrypted and signed, making them usable by any backup application, regardless of its technological foundation. This universal design is a pivotal feature, facilitating smooth transitions across varied environments, such as cloud platforms like AWS or Azure, or even on-site servers.

An event bus manages the distribution of these tokens, operating as a decentralized, event-driven system powered by tools like Kafka, RabbitMQ, or Google Pub/Sub. It sends the token out to a group of backup applications, which monitor these broadcasts and signal their readiness to take on the specified role. This quick, low-latency distribution allows the first capable backup to step up without human involvement, cutting down on downtime and boosting responsiveness. The decentralized structure of this process prevents choke points, ensuring the system can scale effectively across expansive networks.

After a backup application accepts the token, a gateway adjusts its routing policies to shift traffic from the failing application to the backup. Using tools like Envoy Proxy, HAProxy, or Istio, the gateway updates its YAML configurations through automated API calls, redirecting traffic without delay. This automation eliminates the need for manual oversight, achieving zero downtime, which is crucial in high-pressure settings where uninterrupted service is essential. The gateway's ability to adapt instantly to the backup's endpoint highlights the system's practical adaptability.

One of the invention's standout qualities is its platform-agnostic tokenization, which differs markedly from conventional, rigid, application-specific policies. By producing dynamic tokens customized to the needs and abilities of backup applications, it ensures compatibility across different platforms. For example, a token created for an OAuth 2.0 process on a failing app can be utilized by a backup with a different identity provider, like Okta or Azure AD, without requiring extensive setup changes. This versatility makes the system highly applicable across a range of technological contexts.

The use of generative artificial intelligence to craft tokens in real time is another distinctive element. Rather than relying on fixed policy templates, the AI generates tokens based on the current ecosystem state, considering the failing application's specifics and the backup's strengths. This real-time tailoring enhances performance during failover, ensuring the backup can manage the workload effectively. Trained on historical data, the AI's predictive abilities further improve its capacity to address network challenges proactively.

The event-driven framework, enabled by the event bus, enhances both resilience and speed. By allowing backup applications to self-select based on their availability—indicated through acceptance signals—the system distributes decision-making, reducing delays compared to centralized methods. This approach ensures traffic redirection happens quickly, often in milliseconds, preserving user experience and transaction reliability during failures.

The dynamic updating of gateway policies is a practical advancement, automating traffic rerouting without human input. Once a backup accepts a token, the gateway reconfigures itself to direct traffic accordingly, leveraging familiar tools like Istio or Envoy Proxy. This feature shines in situations like HTTPS traffic filtering, where maintaining secure connections without interruption is vital, demonstrating the system's real-world utility.

Privacy is safeguarded through federated learning, which refines the AI models'token generation without compromising sensitive data across platforms. This method aggregates insights from distributed data while concealing proprietary details, aligning with regulations like GDPR or PCI DSS. It allows the system to improve continuously while maintaining security, appealing to organizations prioritizing data protection.

The deployment of the system as containerized microservices across edge and cloud environments boosts its scalability and responsiveness. Using platforms like Kubernetes, components such as the AI cluster, monitoring system, and gateway can scale dynamically with demand, functioning efficiently in both localized edge setups and vast cloud infrastructures. This adaptability ensures the invention can support networks of varying sizes, from small-scale setups to large enterprise systems.

In a practical scenario, consider an application responsible for data validation hitting its failure threshold. The monitoring system detects this, prompting the AI cluster to pinpoint a backup and generate a token. The event bus shares it, a backup signals its readiness, and the gateway redirects traffic—all seamlessly. This example illustrates the system's ability to maintain continuity for specific functions, not just entire applications.

The invention also handles complex cases, like simultaneous failures in multiple functions, by creating composite tokens that address issues such as authentication and load balancing at once. This capability provides thorough failover support, adapting to the intricate demands of modern networks where applications often juggle multiple tasks. The system's proactive nature, reinforced by performance validation after redirection, ensures dependability throughout the process.

Overall, this invention integrates AI-driven tokenization, real-time monitoring, event-driven coordination, and automated traffic management into a resilient, interoperable network solution. Its primary strengths—platform independence, dynamic flexibility, decentralized efficiency, and privacy protection—tackle persistent failover challenges, delivering a scalable system that grows with network needs.

Various example embodiments in the disclosure are designed to fulfill the objectives previously mentioned, drawing on the illustrations provided within this disclosure. These illustrations showcase a variety of systems and methods for putting the disclosed concepts into practice. The system architecture diagram illustrates the interconnected components, including the AI model cluster, network monitoring system, generative AI, event bus, and gateway, while the flow diagram outlines the operational sequence from monitoring to traffic redirection. The sequence diagram details interactions among components, the class diagram offers a software structure, and the combination architecture-flow diagram merges structure with process, all demonstrating practical implementations. It is understood that different approaches to implementation are feasible, and adjustments to both the structure and operation of these systems and methods are permissible. Thus, the description elaborates on numerous connections among components, which should be understood in a flexible sense. Unless specifically noted otherwise, such connections may be direct or indirect and can be facilitated through either wired or wireless means. This document is not intended to limit the form or type of these connections, allowing for versatility in how the system is deployed and operated.

Various types of artificial intelligence may be utilized in accordance with various aspects of the invention. Supervised learning is a type of artificial intelligence where a model is trained on a dataset with labeled examples, meaning each input is paired with a correct output, allowing the model to learn relationships and predict outcomes for new data. In this invention, supervised learning is highly relevant to the cluster of AI models responsible for generating policies for network functions like authentication, authorization, or load balancing. These models are trained using historical application performance data—such as CPU usage trends or error rates—and protocol specifications as inputs, with outputs labeled as the appropriate policies or backup selections for specific failure conditions. For instance, a model might be trained to recognize that a spike in authentication latency above 500 milliseconds historically correlates with a need for a token specifying a particular backup application, enabling it to predict and generate such tokens accurately in real time. Examples of tools to implement this include TensorFlow, which can use algorithms like logistic regression to classify failure scenarios, or PyTorch, which might employ decision trees to map network metrics to failover strategies, ensuring precise policy generation based on past patterns.

Generative artificial intelligence involves models that create new data or content, such as text, images, or structured outputs, by learning the underlying distribution of training data. This type is integral to the invention's token creation process, where the generative AI produces platform-agnostic tokens containing metadata about the failing network function, application features, and communication protocols. It applies specifically to the real-time generation of customized tokens that adapt to the current state of the ecosystem, moving beyond static policies to ensure compatibility across diverse backup applications. For example, it might generate a token for a failing data validation function that works with backups on AWS or Azure by learning from a variety of validation scenarios, embedding details like supported API endpoints or encryption methods. Tools like fine-tuned OpenAI models, capable of generating structured outputs, or Variational Autoencoders implemented in Python with PyJWT, can craft these tokens, ensuring they are both secure and interoperable across platforms.

Federated learning is an artificial intelligence approach where models are trained across multiple decentralized devices or datasets without sharing raw data, instead aggregating model updates to improve performance while maintaining privacy. In this invention, federated learning is applied to refine the AI cluster's token generation accuracy over time, using performance data from applications across the ecosystem without exposing sensitive information. It is particularly useful for enhancing the models'ability to predict optimal tokens by learning from distributed failover outcomes—for instance, analyzing how often a backup on Google Cloud successfully handles traffic filtering compared to one on Azure, then adjusting token metadata accordingly. This ensures continuous improvement while adhering to privacy standards like GDPR. TensorFlow Federated is an example tool, enabling each application to train a local model on its data and send only parameter updates to the central cluster, refining the system's effectiveness without compromising confidentiality.

Reinforcement learning is a type of artificial intelligence where an agent learns to make decisions by taking actions in an environment, receiving rewards or penalties based on outcomes, and optimizing for a long-term goal through trial and error. This approach could enhance the invention's event bus or generative AI components. For the event bus, it might optimize the selection of backup applications by rewarding choices that minimize failover latency or maximize throughput, learning over time which backups perform best under specific conditions—such as selecting an Azure VM with low CPU usage over an overloaded AWS instance. For the generative AI, it could refine token metadata, like adding priority fields, by rewarding tokens that lead to successful failovers. Deep Q-Networks implemented in PyTorch could be used, where the agent explores backup options or token configurations, gradually improving its strategy based on real-time network feedback, enhancing the system's adaptability and efficiency.

Predictive analytics, a subset of supervised learning, uses historical data to forecast future events, often through statistical or machine learning techniques. In this invention, it applies to both the network monitoring system and the AI cluster to preempt failures and optimize responses. The monitoring system could use it to predict when an application's health metrics—like memory usage approaching 90% over an hour—will cross a threshold, triggering token generation before a failure fully occurs, thus reducing reaction time. The AI cluster might predict the best backup by analyzing trends, such as which application historically handles load balancing most effectively during peak traffic. Tools like scikit-learn can implement simpler models like ARIMA for time-series forecasting, while TensorFlow's LSTM networks could tackle complex patterns, enabling proactive token creation and backup selection that anticipates network challenges, strengthening the system's preventive capabilities.

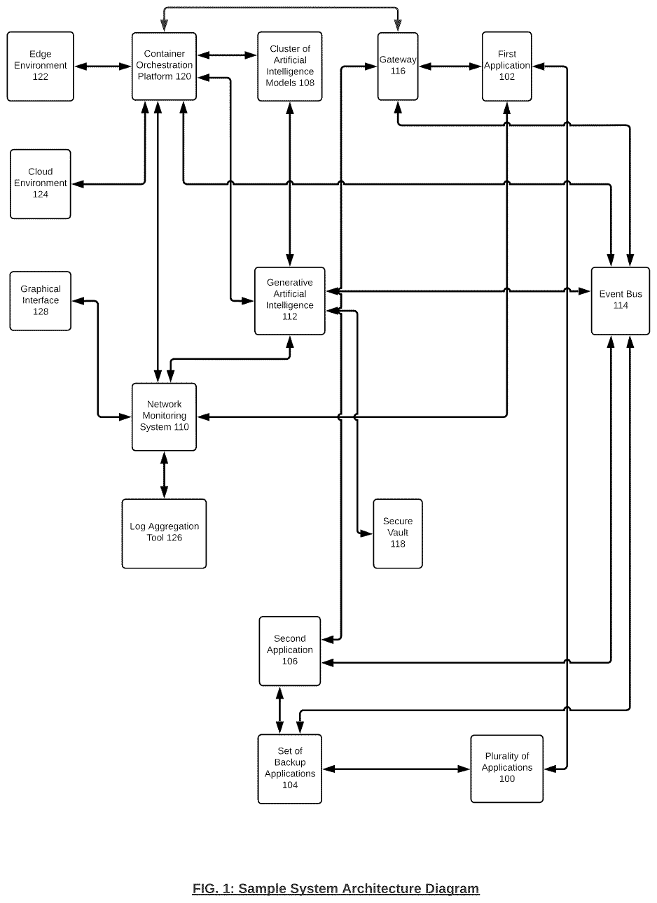

The system architecture diagram, designated as FIG. 1, presents a sample depiction of various aspects of the invention's structural composition, illustrating the seamless integration of components designed to maintain network resiliency across a wide-ranging set of applications. Central to the diagram, the Plurality of Applications (100) encompasses the full ecosystem of software entities that the system protects and optimizes, such as an extensive suite of enterprise-grade tools including customer relationship management platforms hosted on Salesforce, real-time inventory tracking systems running on Google Cloud Platform, or payment processing microservices operating on AWS infrastructure. This collection represents a diverse array of applications, potentially distributed across multiple data centers or cloud providers, each with distinct operational profiles—such as varying transaction volumes, data throughput needs, or security requirements—that the system harmonizes to ensure continuous and reliable performance under varying conditions.

Within this ecosystem, the First Application (102) serves as a primary operational entity, exemplified by a high-traffic payment processing service deployed on an AWS EC2 instance paired with a PostgreSQL database, handling thousands of financial transactions per minute with stringent uptime requirements. This application might process credit card payments for an e-commerce platform, relying on low-latency responses and high availability, yet it could encounter stressors like sudden surges in user demand or intermittent server resource constraints, necessitating immediate failover capabilities to maintain service continuity. Also within the ecosystem, the Set of Backup Applications (104) comprises a group of standby substitutes, such as a redundant array of payment processing services hosted on Azure Virtual Machines, each meticulously configured with identical business logic, database replication, and API endpoints to mirror the primary application's functionality. Contained within this group, the Second Application (106) represents a specific backup instance, perhaps a single Azure VM equipped with auto-scaling policies, pre-synchronized with the latest transaction data, and optimized for rapid deployment to assume the primary role seamlessly when triggered.

The Cluster of Artificial Intelligence Models (108) forms the intellectual foundation of the system, tasked with generating sophisticated policies for network functions including authentication, authorization, data validation, traffic filtering, load balancing, and encryption offloading. This component could be implemented as a distributed set of Kubernetes pods running TensorFlow and PyTorch frameworks on a Google Cloud Compute Engine cluster, leveraging NVIDIA GPUs to accelerate training on extensive datasets comprising months or years of historical application performance metrics, network traffic logs, and protocol specifications. Each model within this cluster might specialize in a specific function—for instance, one model predicting authentication failover needs based on user login patterns, while another optimizes load balancing by analyzing server response times—enabling precise, context-aware policy generation that adapts to real-time network dynamics.

The Network Monitoring System (110) functions as the vigilant overseer of application health across the ecosystem, potentially utilizing Prometheus for real-time metric collection, Grafana for interactive visualization dashboards, and the ELK stack (Elasticsearch, Logstash, Kibana) for comprehensive log aggregation, all deployed on a dedicated monitoring node within a private data center. This system continuously gathers granular metrics such as CPU utilization percentages, memory consumption measured in gigabytes, error rates per second, and network latency in milliseconds, offering a detailed snapshot of operational status for each application within the Plurality of Applications (100). It might integrate with custom APIs to extract application-specific indicators, like transaction failure rates from the payment processing service, or use agent-based monitoring to capture disk I/O statistics, ensuring a robust dataset that drives timely and informed failover decisions.

The Generative Artificial Intelligence (112) is responsible for crafting platform-agnostic tokens that facilitate seamless failover coordination, potentially implemented as a Python-based service leveraging PyJWT and running on an AWS Lambda function triggered by health degradation alerts from the monitoring system. This component generates tokens embedding metadata—such as the failing network function (e.g., load balancing), the First Application's (102) feature set (e.g., supported REST API endpoints), and the communication protocol (e.g., HTTPS)—secured with encryption keys retrieved from a vault. It could extend the RFC 7519 JSON Web Token standard with custom fields, like failover priority levels or application-specific routing hints, ensuring compatibility across disparate platforms such as AWS, Azure, or on-premises servers, while supporting rapid integration with varying identity providers like Okta or Azure AD.

The Event Bus (114) orchestrates token distribution and backup application coordination, possibly realized with Apache Kafka or RabbitMQ deployed on a high-availability messaging cluster hosted in a private cloud environment like VMware vSphere. This component manages high-throughput, low-latency communication, capable of broadcasting tokens to the Set of Backup Applications (104) at rates exceeding thousands of messages per second, and processing acceptance signals from potential backups like the Second Application (106). It might employ a custom event schema to prioritize responses based on metrics like current CPU load or memory availability, ensuring the most capable backup is selected, and could integrate with monitoring tools to log distribution events for post-incident analysis.

The Gateway (116), positioned to align with the Plurality of Applications (100), governs network traffic routing, dynamically redirecting requests from failing applications to their designated backups. This could be an Istio service mesh or Envoy Proxy deployed on a Kubernetes cluster within a hybrid cloud setup, equipped with YAML-based routing configurations that update in real-time via RESTful API calls. For example, it might reroute HTTPS traffic from the First Application (102) on AWS to the Second Application (106) on Azure, leveraging service discovery mechanisms like Consul to maintain seamless connectivity, achieving failover times in the millisecond range to minimize disruptions for end-users processing payments or accessing inventory data.

The Secure Vault (118), closely associated with the Generative Artificial Intelligence (112), safeguards encryption keys used in token generation, potentially implemented with HashiCorp Vault running on a hardened Ubuntu server within the same AWS Virtual Private Cloud (VPC). This component ensures tokens remain secure during creation and transmission, storing keys in a FIPS 140-2 compliant key management system and providing them on-demand to the AI for signing and encrypting tokens with algorithms like AES-256. It might support key rotation policies to enhance security, aligning with compliance standards such as GDPR for user data or PCI DSS for financial transactions, ensuring the integrity of sensitive failover operations.

The Container Orchestration Platform (120), integrated with the Plurality of Applications (100), manages the deployment, scaling, and lifecycle of all system components as microservices, such as Kubernetes or Docker Swarm running across a fleet of on-premises Dell PowerEdge servers and cloud-based Google Cloud Platform nodes. This platform could use Helm charts to deploy the Cluster of AI Models (108), Network Monitoring System (110), and Gateway (116), with auto-scaling policies adjusting pod counts based on real-time traffic load—for instance, spinning up additional Gateway instances during peak transaction hours. It might incorporate health checks and rolling updates to ensure zero-downtime deployments, providing a resilient foundation that spans edge and cloud environments.

The Edge Environment (122), closely tied to the Container Orchestration Platform (120), represents localized computing resources that enhance system responsiveness, such as Raspberry Pi clusters or Intel NUCs deployed at retail branch locations running lightweight monitoring agents or gateway proxies. These edge nodes might preprocess health metrics locally—filtering out noise like transient latency spikes—before syncing with the central system via a secure MQTT broker, reducing latency for time-sensitive applications like real-time inventory updates or point-of-sale systems within the Plurality of Applications (100). They could also host lightweight versions of the Event Bus (114) for local coordination, minimizing reliance on distant cloud resources.

The Cloud Environment (124), also integrated with the Container Orchestration Platform (120), signifies the broader cloud infrastructure supporting the system's scalability and computational needs, such as Microsoft Azure or Google Cloud Platform instances hosting the bulk of the AI models, event bus, and monitoring services. This environment might include preemptible VMs for cost-efficient AI training, high-performance SSDs for rapid log storage, and global load balancers to distribute traffic across regions, ensuring the system can handle enterprise-scale workloads. It could leverage cloud-native tools like Azure Monitor or GCP Stackdriver for additional telemetry, complementing the Network Monitoring System (110).

The Log Aggregation Tool (126), associated with the Network Monitoring System (110), processes and consolidates application logs, potentially using Elasticsearch on a dedicated logging server with terabytes of storage to handle verbose debug logs, error traces, and transaction records from the Plurality of Applications (100). This tool might index logs with custom fields—like application ID or timestamp—enabling rapid querying for root cause analysis, and could integrate with alerting systems like PagerDuty to notify administrators of persistent issues, enhancing the system's diagnostic capabilities.

The Graphical Interface (128), paired with the Log Aggregation Tool (126) and Network Monitoring System (110), provides a visual representation of system health, such as a Grafana dashboard running on a visualization server with multi-user access. This interface might display real-time charts of metrics like latency in milliseconds, throughput in requests per second, or error rates as percentages, alongside historical trends for the First Application (102) and Second Application (106), enabling administrators to monitor failover performance. It could feature interactive widgets for drilling into specific incidents, such as a spike in payment failures, and exportable reports for compliance audits, offering a user-friendly lens into the system's operational state.

Collectively, these components form a sophisticated architecture where the Cluster of Artificial Intelligence Models (108) empowers the Generative Artificial Intelligence (112) to create secure tokens via the Secure Vault (118), which the Event Bus (114) distributes to orchestrate failover within the Plurality of Applications (100), managed by the Gateway (116). The Network Monitoring System (110), supported by the Log Aggregation Tool (126) and Graphical Interface (128), ensures proactive oversight, while the Container Orchestration Platform (120) deploys this ecosystem across the Edge Environment (122) and Cloud Environment (124), delivering a resilient, scalable, and observable solution for network continuity.

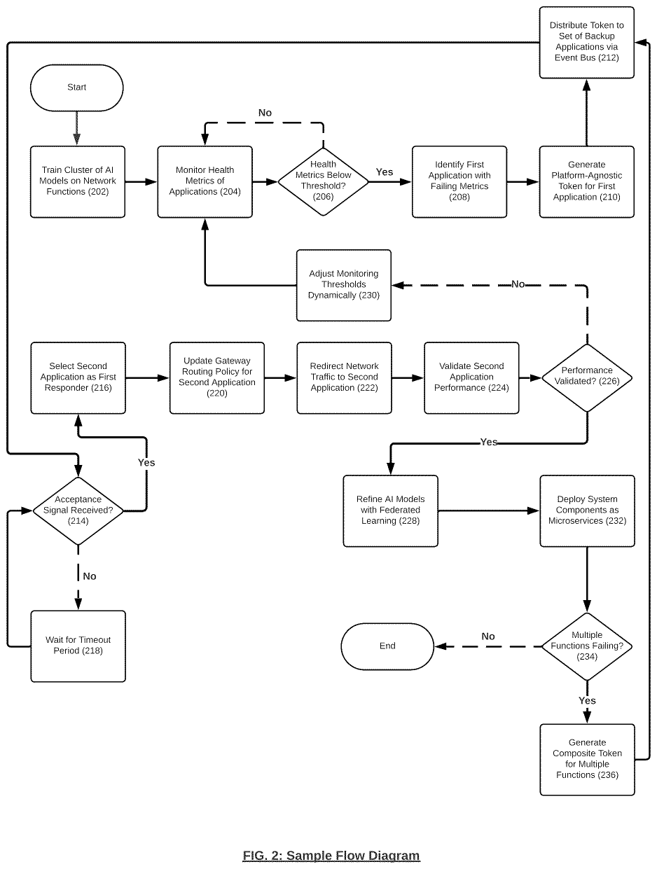

The flow diagram, identified as FIG. 2, presents a sample representation of the invention's operational workflow, delineating each step required to maintain network resiliency across a diverse set of applications. The process commences with a step labeled “Start,” which serves as the initiation point for the entire sequence, potentially triggered by a system administrator through a command-line interface on a central management server or automatically upon system startup within a network orchestration platform like Ansible (200). This initial action sets the stage for a robust resiliency mechanism, ensuring that all subsequent steps are executed in a coordinated manner to address application failures and maintain service continuity across an enterprise-grade ecosystem.

Following this, the flow transitions to a step labeled “Train Cluster of AI Models on Network Functions,” where a cluster of artificial intelligence models is prepared to handle various network functions such as authentication, authorization, data validation, traffic filtering, load balancing, and encryption offloading (202). This step could be implemented by deploying TensorFlow and PyTorch frameworks on a high-performance computing cluster hosted on Google Cloud Platform, utilizing GPUs to train models on extensive datasets comprising historical application performance metrics—like CPU usage trends over months—protocol specifications such as HTTP/2 standards, and network traffic logs capturing peak load scenarios. Each model might be specialized, with one trained on authentication patterns using OAuth 2.0 token exchanges and another on load balancing using server response time distributions, ensuring precise policy generation tailored to real-time needs.

The flow progresses to a step labeled “Monitor Health Metrics of Applications,” where the system continuously assesses the operational status of all applications within the ecosystem (204). This could be executed using a Network Monitoring System integrating Prometheus for metric collection, running on a dedicated Ubuntu server, pulling data like processor utilization percentages, memory consumption in gigabytes, and error rates per second from applications hosted on AWS EC2 instances. Logs might be aggregated with Elasticsearch, capturing detailed transaction traces from a payment processing service, while Grafana dashboards provide visual feedback, enabling administrators to spot anomalies like a sudden spike in latency exceeding 500 milliseconds.

Next, the flow reaches a decision point labeled “Health Metrics Below Threshold?” which evaluates whether any application's performance has fallen below predefined acceptable limits (206). This step might involve a Python script within the monitoring system comparing real-time metrics against thresholds stored in a PostgreSQL database—such as 80% CPU usage or 5% error rate for a web server—configured via a YAML file tailored to each application's operational profile. If the condition is not met, the process loops back to continuous monitoring, ensuring persistent vigilance without unnecessary interventions.

If the threshold is breached, the flow advances to a step labeled “Identify First Application with Failing Metrics,” pinpointing the specific application experiencing distress (208). This could be implemented with a Grafana alert rule highlighting a payment processing application on AWS showing excessive memory usage, triggering a notification via Slack or email to the operations team, with the system logging the event in a central audit trail for compliance tracking. The identification leverages unique application IDs and correlates them with metric sources, ensuring accurate targeting for subsequent failover actions.

The process then moves to a step labeled “Generate Platform-Agnostic Token for First Application,” where a token is created to facilitate failover coordination (210). This might employ a generative AI service running on AWS Lambda, coded in Python with PyJWT, generating a JSON Web Token embedding metadata such as the failing function (e.g., load balancing), the application's REST API endpoints, and the HTTPS protocol, encrypted with a 256-bit key from HashiCorp Vault. The token could include custom fields like a priority score, ensuring compatibility with backup applications on Azure or Google Cloud, and be signed to prevent tampering during transmission.

Subsequently, the flow proceeds to a step labeled “Distribute Token to Set of Backup Applications via Event Bus,” disseminating the token to potential backup candidates (212). This step could utilize Apache Kafka deployed on a Red Hat OpenShift cluster, broadcasting the token to a topic subscribed by redundant payment processing services, with a throughput capacity of 10,000 messages per second. The event bus might implement a round-robin distribution strategy, ensuring even load across backups, and log each broadcast event for debugging purposes.

The sequence advances to a decision point labeled “Acceptance Signal Received?” assessing whether a backup application has signaled readiness to assume the failed function (214). This could be coded as a Kafka consumer group in Java, listening for responses within a 30-second timeout window, with each backup application running a lightweight agent that evaluates its current resource availability—such as 50% CPU idle—and responds with a readiness message. The system might prioritize responses based on latency, selecting the fastest signal to minimize downtime.

If a signal is received, the flow continues to a step labeled “Select Second Application as First Responder,” designating the earliest responding backup (216). This might involve a selection algorithm in Python, running on the event bus server, choosing a backup Azure VM with sufficient capacity (e.g., 16 GB RAM available) as the Second Application, logging the choice in a MongoDB database for traceability. If no signal is received, the flow diverts to a step labeled “Wait for Timeout Period,” pausing briefly before retrying (218). This could be a simple sleep function set to 30 seconds, implemented in the consumer code, after which the process loops back to check for signals again, ensuring exhaustive attempts to find a responder.

Once a responder is selected, the flow moves to a step labeled “Update Gateway Routing Policy for Second Application,” adjusting traffic direction to the backup (220). This could be executed by an Istio service mesh on Kubernetes, updating its Envoy Proxy configuration via a REST API call, modifying routing rules to direct HTTPS traffic to the Second Application's IP address, with changes applied in under 100 milliseconds. The gateway might use a canary deployment strategy, initially routing 10% of traffic to validate stability before full redirection.

The flow then progresses to a step labeled “Redirect Network Traffic to Second Application,” completing the failover action (222). This might see the gateway fully shifting HTTP requests from the AWS-based First Application to the Azure-based Second Application, leveraging DNS resolution and service discovery via Consul, ensuring end-users experience no interruption in payment processing, with failover logged in a centralized system for performance review.

Following this, the flow reaches a step labeled “Validate Second Application Performance,” confirming the backup's effectiveness post-redirection (224). This could utilize Prometheus to scrape metrics like request latency (e.g., under 200 ms) and throughput (e.g., 150 requests per second) from the Second Application, with a validation script comparing these against SLAs stored in a configuration file, alerting via PagerDuty if thresholds are breached. The step ensures the failover maintains service quality, critical for applications like financial transaction systems.

The process advances to a decision point labeled “Performance Validated?” determining if the failover meets operational standards (226). This might involve a Go-based microservice analyzing metrics against a minimum throughput of 100 requests per second, with a “Yes” outcome indicating success and a “No” prompting adjustments. If validated, the flow proceeds to a step labeled “Refine AI Models with Federated Learning,” enhancing model precision (228). This could employ TensorFlow Federated across distributed nodes, aggregating anonymized performance data from the Plurality of Applications without centralizing sensitive information, improving token generation accuracy for future failovers.

If not validated, the flow diverts to a step labeled “Adjust Monitoring Thresholds Dynamically,” recalibrating detection criteria (230). This might adjust the CPU threshold from 80% to 75% using a machine learning model trained on recent network trends, implemented in Python with scikit-learn, looping back to monitoring to refine sensitivity. From the refinement step, the sequence moves to a step labeled “Deploy System Components as Microservices,” integrating the system into the infrastructure (232). This could deploy the AI cluster, monitoring system, and gateway as Docker containers via Kubernetes Helm charts across AWS and edge nodes, with auto-scaling policies ensuring resource availability.

The flow then reaches a decision point labeled “Multiple Functions Failing?” assessing broader degradation (234). This might use a correlation analysis script in R, checking if authentication and load balancing metrics both drop below thresholds (e.g., 90% success rate and 80% CPU), indicating a compound failure. If “Yes,” the process advances to a step labeled “Generate Composite Token for Multiple Functions,” addressing complex issues (236). This could generate a token with metadata for both functions using the generative AI, looping back to distribution, implemented with a batch processing script to handle multiple metadata fields efficiently.

If “No,” the flow concludes with a step labeled “End,” marking successful completion (238). This might log the failover event in a Splunk instance, archiving details like timestamp and responder ID, preparing the system for future cycles. Each step's implementation leverages specific technologies—Prometheus, Kafka, Kubernetes—ensuring a robust, scalable, and adaptive flow that maintains network resiliency across diverse applications, with detailed logging and validation enhancing reliability and observability.

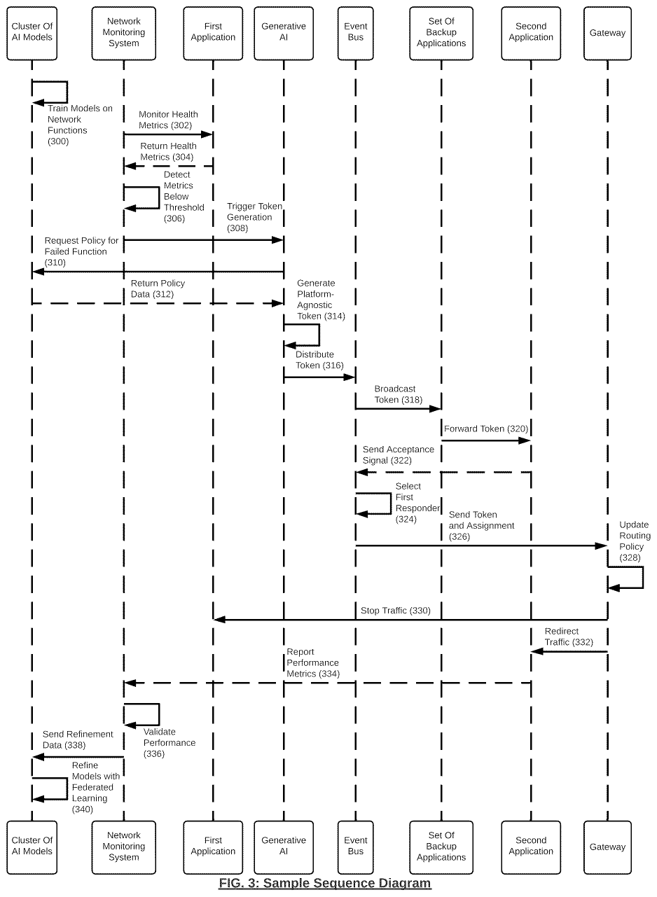

The sequence diagram, identified as FIG. 3, provides a sample illustration of the invention's operational interactions, tracing the communication flow among distinct actors to ensure network resiliency across a diverse application ecosystem. The diagram begins with the actor Cluster Of AI Models, which initiates the sequence with a self-directed message labeled “Train Models on Network Functions,” marking the foundational step of preparing artificial intelligence models for policy generation (300). This could be implemented by deploying TensorFlow and PyTorch frameworks on a Google Cloud Compute Engine cluster, where models are trained on extensive datasets of historical network performance—such as authentication request rates or load balancing metrics—using GPU acceleration to process terabytes of data, ensuring readiness to generate failover policies tailored to specific functions like encryption offloading.

Following this, the Network Monitoring System sends a message to the First Application labeled “Monitor Health Metrics,” initiating continuous oversight of application performance (302). This might involve a Prometheus instance running on an Ubuntu server, querying the First Application—a payment processing service on AWS EC 2—via its metrics endpoint every 10 seconds to collect data like CPU usage (e.g., 85%), memory consumption (e.g., 12 GB), and error rates (e.g., 3% per minute), with results logged to a time-series database for trend analysis. The First Application responds with a return message labeled “Return Health Metrics,” providing the requested data back to the Network Monitoring System (304). This could be implemented as a lightweight HTTP server within the application, exposing a/metrics endpoint formatted in Prometheus'text-based exposition format, delivering real-time statistics to enable proactive monitoring.

The Network Monitoring System then processes this data with a self-directed message labeled “Detect Metrics Below Threshold,” evaluating whether the First Application's performance has degraded beyond acceptable limits (306). This step might use a Python script comparing metrics against thresholds stored in a PostgreSQL database—such as 80% CPU usage or 5% error rate—triggering an alert if breached, with the logic deployed as a containerized microservice for scalability. Upon detection, the Network Monitoring System sends a message to the Generative AI labeled “Trigger Token Generation,” signaling the need for a failover token (308). This could be a REST API call over HTTPS, passing the application ID and failing function (e.g., load balancing) in a JSON payload, secured with mutual TLS authentication to ensure integrity.

The Generative AI then sends a message to the Cluster Of AI Models labeled “Request Policy for Failed Function,” seeking the necessary policy data (310). This might be implemented as a gRPC call from an AWS Lambda function to the AI cluster, specifying the function and application context, with the request logged to an audit trail for traceability. The Cluster Of AI Models responds with a return message labeled “Return Policy Data,” delivering the predicted policy (312). This could return a serialized model output—such as a JSON object detailing routing rules—generated by a PyTorch model, transmitted back via gRPC with compression to optimize bandwidth, reflecting the cluster's training on historical failover scenarios.

Next, the Generative AI processes this with a self-directed message labeled “Generate Platform-Agnostic Token,” creating a token for failover coordination (314). This might involve a Python service using PyJWT to encode metadata—like the failing function, application features (e.g., REST endpoints), and protocol (HTTPS)—into a token, encrypted with a 256-bit AES key from HashiCorp Vault, ensuring cross-platform compatibility. The Generative AI then sends a message to the Event Bus labeled “Distribute Token,” forwarding the token for dissemination (316). This could be a Kafka producer publishing the token to a dedicated topic, configured with a replication factor of 3 for high availability, logging the event to a monitoring dashboard.

The Event Bus sends a message to the Set Of Backup Applications labeled “Broadcast Token,” distributing it to potential backups (318). This might use Kafka's publish-subscribe model, broadcasting to a consumer group of backup payment processing services on Azure VMs, with a throughput of 10,000 messages per second. The Set Of Backup Applications forwards this to the Second Application with a message labeled “Forward Token,” targeting a specific backup (320). This could be an internal routing mechanism within the backup cluster, passing the token via an in-memory queue to the Second Application, identified by its unique service ID.

The Second Application responds with a return message to the Event Bus labeled “Send Acceptance Signal,” indicating readiness to assume the failed function (322). This might be a Kafka message from a Java-based agent running on the Azure VM, signaling 60% CPU availability and 16 GB free memory, transmitted within 50 milliseconds to minimize latency. The Event Bus processes this with a self-directed message labeled “Select First Responder,” designating the Second Application (324). This could be a selection logic in Go, prioritizing the earliest signal, with the decision stored in a Redis cache for quick retrieval in future steps.

The Event Bus then sends a message to the Gateway labeled “Send Token and Assignment,” transferring the token and backup designation (326). This might be an HTTPS POST request carrying the token and Second Application's IP address, secured with OAuth 2.0 tokens, logged to a central audit system. The Gateway processes this with a self-directed message labeled “Update Routing Policy,” adjusting traffic direction (328). This could involve an Istio service mesh updating its Envoy Proxy configuration via a REST API, modifying YAML rules to route traffic to the Second Application, applied in under 100 ms with a rollback option if needed.

The Gateway sends a message to the First Application labeled “Stop Traffic,” halting its traffic flow (330). This might adjust routing weights to 0% for the AWS instance, implemented via an Istio VirtualService update, ensuring a clean handoff. The Gateway then sends a message to the Second Application labeled “Redirect Traffic,” initiating traffic flow to the backup (332). This could fully redirect HTTPS requests to the Azure VM's endpoint, using DNS resolution and Consul service discovery, achieving failover in milliseconds, with traffic logs captured for analysis.

The Second Application responds with a return message to the Network Monitoring System labeled “Report Performance Metrics,” providing post-redirection data (334). This might expose a/metrics endpoint returning latency (e.g., 150 ms) and throughput (e.g., 200 requests/second), scraped by Prometheus every 15 seconds. The Network Monitoring System processes this with a self-directed message labeled “Validate Performance,” confirming the failover's success (336). This could use a Python validation script checking against SLAs (e.g., latency<200 ms), with results visualized in Grafana and alerts sent via Slack if thresholds are unmet.

The Network Monitoring System sends a message to the Cluster Of AI Models labeled “Send Refinement Data,” sharing performance insights (338). This might transmit anonymized metrics via a secure MQTT broker, including failover duration and success rates, for model improvement. The sequence concludes with the Cluster Of AI Models processing a self-directed message labeled “Refine Models with Federated Learning,” enhancing accuracy (340). This could employ TensorFlow Federated, aggregating data across distributed nodes without centralizing sensitive information, updating models hourly, with changes deployed via Kubernetes rolling updates, ensuring continuous adaptation to network conditions. Each sequence leverages specific technologies—Prometheus, Kafka, Istio—implemented with precision to orchestrate a resilient, responsive failover process.

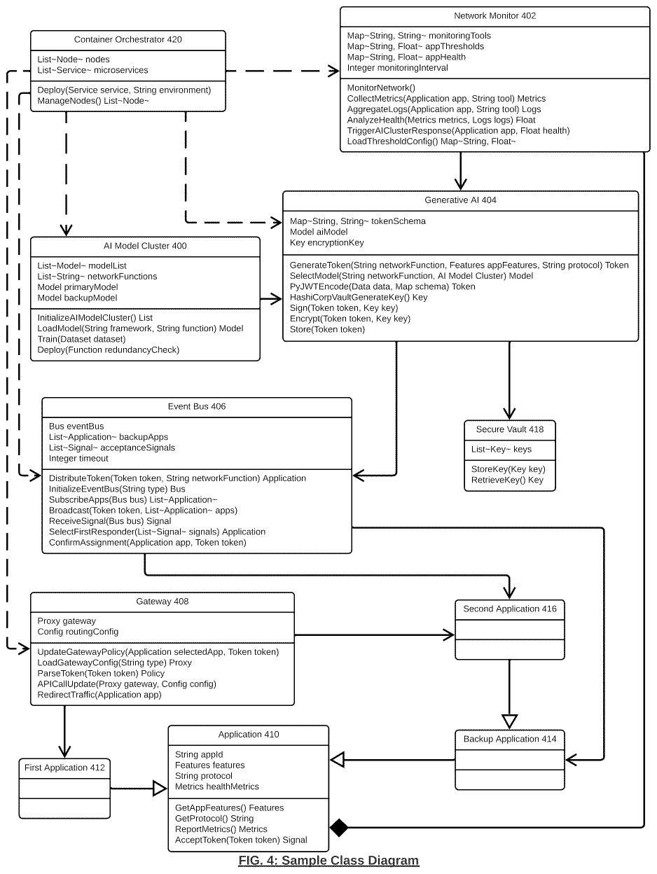

The class diagram, designated as FIG. 4, offers a sample representation of the invention's software architecture, delineating the classes, their attributes, methods, and relationships that collectively ensure network resiliency across a diverse application ecosystem. The AI Model Cluster (400) class serves as the intellectual cornerstone, encapsulating the artificial intelligence capabilities critical to policy generation for network functions such as authentication, authorization, data validation, traffic filtering, load balancing, and encryption offloading. Its attributes include modelList, a collection of trained models potentially stored as a Java ArrayList of TensorFlow Model objects; networkFunctions, a List<String> enumerating supported functions like “authentication” or “load_balancing”; primaryModel, a Model object representing the active instance; and backupModel, another Model object for redundancy. Methods encompass InitializeAIModelCluster(), which returns the configured model list after setting up a cluster using Kubernetes pods on Google Cloud, leveraging TensorFlow and PyTorch for training; LoadModel(framework: String, function: String), returning a Model instance loaded from a specified framework; Train(dataset: Dataset), training models on historical data like server logs; and Deploy(redundancyCheck: Function), ensuring high availability through active-passive setups.

The Network Monitor (402) class oversees application health, with attributes like monitoringTools, a Map<String, String> pairing tools to roles (e.g., “Prometheus”: “metrics”); appThresholds, a Map<String, Float> storing thresholds (e.g., “app 1”: 0.8 for 80% CPU); appHealth, a Map<String, Float> tracking real-time health scores; and monitoringInterval, an Integer defining check frequency in seconds. Its methods include MonitorNetwork(), a continuous loop implemented in Python on an Ubuntu server using Prometheus to poll metrics; CollectMetrics(app: Application, tool: String), returning Metrics objects from tools like Prometheus; AggregateLogs(app: Application, tool: String), returning Logs via Elasticsearch; AnalyzeHealth(metrics: Metrics, logs: Logs), calculating health scores; TriggerAIClusterResponse(app: Application, health: Float), sending alerts via REST API; and LoadThresholdConfig(), fetching thresholds from a YAML file.

The Generative AI (404) class handles token creation, with attributes such as tokenSchema, a Map<String, String> defining RFC 7519 standards plus custom fields (e.g., “app_features”); aiModel, a Model object from the AI cluster; and encryptionKey, a Key object for security. Methods include GenerateToken(networkFunction: String, appFeatures: Features, protocol: String), returning a Token using PyJWT on AWS Lambda; SelectModel(networkFunction: String, cluster: AIModelCluster), choosing the appropriate model; PyJWTEncode(data: Data, schema: Map), encoding tokens; HashiCorpVaultGenerateKey(), creating keys; Sign(token: Token, key: Key) and Encrypt(token: Token, key: Key), securing tokens; and Store(token: Token), saving them to a vault.

The Event Bus (406) class coordinates token distribution, with attributes like eventBus, a Bus object (e.g., Kafka instance); backupApps, a List<Application> of subscribers; acceptanceSignals, a List<Signal> for responses; and timeout, an Integer in seconds. Methods include DistributeToken(token: Token, networkFunction: String), returning the selected Application via Kafka; InitializeEventBus(type: String), setting up the bus; SubscribeApps(bus: Bus), listing subscribers; Broadcast(token: Token, apps: List<Application>), sending tokens; ReceiveSignal(bus: Bus), collecting signals; SelectFirstResponder(signals: List<Signal>), picking the first responder; and ConfirmAssignment(app: Application, token: Token), finalizing the choice.

The Gateway (408) class manages traffic routing, with attributes gateway, a Proxy object (e.g., Envoy Proxy); and routingConfig, a Config object for rules. Methods include UpdateGatewayPolicy(selectedApp: Application, token: Token), updating routes via API; LoadGatewayConfig(type: String), initializing the proxy; ParseToken(token: Token), extracting policies; APICallUpdate(gateway: Proxy, config: Config), applying changes; and RedirectTraffic(app: Application), rerouting traffic.

The Application (410) class represents generic applications, with attributes appId, a String identifier; features, a Features object for capabilities; protocol, a String like “HTTPS”; and healthMetrics, a Metrics object. Methods include GetAppFeatures(), returning features; GetProtocol(), returning the protocol; ReportMetrics(), providing metrics; and AcceptToken(token: Token), signaling readiness. The First Application (412) class extends Application (410), inheriting all attributes and methods, representing a primary instance like a payment service on AWS. The Backup Application (414) class also extends Application (410), serving as a potential substitute, while the Second Application (416) class extends Backup Application (414), acting as the specific failover target, such as an Azure VM.

The Secure Vault (418) class secures keys, with attribute keys, a List<Key> of encryption keys, and methods StoreKey(key: Key) and RetrieveKey(), implemented with HashiCorp Vault on a secure server. The Container Orchestrator (420) class manages deployment, with attributes nodes, a List<Node> of servers; and microservices, a List<Service> of components. Methods include Deploy(service: Service, environment: String), using Kubernetes across edge and cloud; and ManageNodes(), maintaining node health.

Relationships show AI Model Cluster (400) associated with Generative AI (404) for model provision, Network Monitor (402) composing Application (410) instances, and triggering Generative AI (404). Generative AI (404) connects to Event Bus (406) for token distribution, which links to Backup Application (414) and Second Application (416) for signaling. Event Bus (406) informs Gateway (408), which interacts with First Application (412) and Second Application (416) for traffic management. Generative AI (404) uses Secure Vault (418), and Container Orchestrator (420) depends on all major classes for deployment, with inheritance from Application (410) to First Application (412), Backup Application (414), and Second Application (416). This structure enables a robust, scalable implementation of the resiliency system.

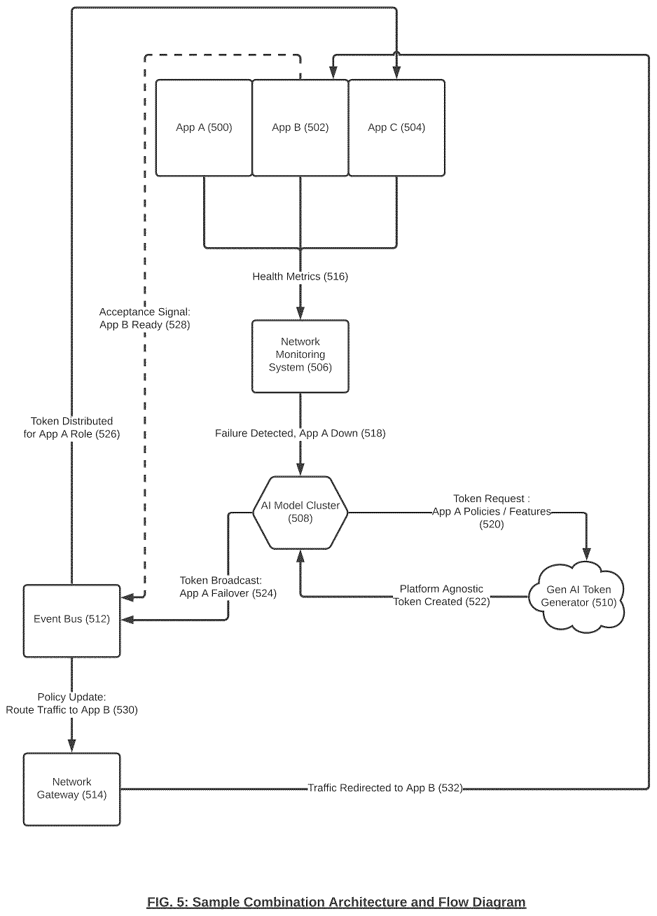

The hybrid system architecture and flow diagram, designated as FIG. 5, presents a sample depiction that integrates the structural components and operational sequence of the platform-agnostic AI-generated token system for network resiliency, as described in various embodiments throughout this disclosure. This illustration serves a dual purpose, offering both a static blueprint of the system's architectural elements and a dynamic walkthrough of the step-by-step process that ensures uninterrupted application failover across a diverse ecosystem of applications, providing an in-depth understanding of how the invention maintains network continuity under varying conditions.

In this example, the architecture includes App A (500), a primary application within the ecosystem, which could be envisioned as a high-traffic payment processing service deployed on an AWS EC2 instance with a PostgreSQL backend, handling thousands of financial transactions per minute for an e-commerce platform, tasked with functions such as HTTPS traffic filtering or OAuth 2.0-based authentication to secure user payments. This application might process credit card authorizations, requiring low-latency responses under stringent uptime requirements, yet it could face challenges like resource exhaustion during peak shopping seasons or network congestion from a sudden influx of users, necessitating a swift and reliable failover mechanism to preserve service integrity. App B (502) stands as a designated backup application, potentially a redundant payment processor hosted on an Azure Virtual Machine, meticulously pre-configured with identical business logic, database replication to mirror App A's (500) transaction logs, and auto-scaling policies to handle variable loads, poised to assume App A's (500) role seamlessly upon detection of failure. App C (504), another backup application within the set, might be a secondary instance running on Google Cloud Platform, equipped with additional computational resources like high-memory VMs or GPU support, providing further redundancy and flexibility to the system, ensuring multiple fallback options to maintain operational continuity across diverse scenarios.

The Network Monitoring System (506) is a cornerstone of the architecture, responsible for vigilantly overseeing the health of all applications within the ecosystem, leveraging advanced tools such as Prometheus for real-time metric collection, Grafana for creating interactive visualization dashboards, and the ELK stack (Elasticsearch, Logstash, Kibana) for aggregating and analyzing detailed logs, capturing a wide array of metrics including CPU usage percentages, memory consumption in gigabytes, error rates per second, and network latency in milliseconds. In the operational flow, this system initiates with Health Metrics (516), where it continuously gathers data from App A (500), such as 85% CPU utilization during a busy sales period, 12 gigabytes of memory usage nearing capacity, or a 4% error rate in transaction processing, storing these metrics in a time-series database for historical comparison and trend analysis. The sequence progresses to Failure Detected, App A Down (518), where the Network Monitoring System (506) identifies that App A (500) has breached a predefined threshold—perhaps 80% CPU usage sustained over 30 seconds or a latency spike exceeding 500 milliseconds—prompting an immediate alert and marking App A (500) as the focal point for failover intervention, a process that might involve cross-referencing real-time data against application-specific SLAs stored in a configuration database.

The AI Model Cluster (508) constitutes the intellectual foundation of the system, comprising a sophisticated array of artificial intelligence models trained on an extensive set of network functions including authentication, authorization, data validation, traffic filtering, load balancing, and encryption offloading, utilizing cutting-edge technologies like TensorFlow for deep learning, PyTorch for flexible model design, and fine-tuned OpenAI models for enhanced predictive capabilities, all orchestrated in an active-passive redundancy configuration to ensure uninterrupted operation. In the flow, this cluster responds to Token Request: App A Policies/Features (520), where the Network Monitoring System (506) requests detailed policies and features specific to App A (500), such as its REST API endpoints for transaction processing, supported OAuth 2.0 scopes, or HTTPS protocol specifications, drawing on the cluster's training with months or years of historical performance data—like peak authentication request rates or load balancing distributions—to formulate a precise policy response. This step might leverage a distributed computing environment on Google Cloud, with models running on GPU-accelerated Kubernetes pods, processing terabytes of data to predict the optimal backup strategy, ensuring the generated policy aligns with App A's (500) operational context.

The Gen AI Token Generator (510) is a critical architectural component, tasked with crafting the platform-agnostic token that drives the failover process, employing Python-based libraries such as PyJWT for token encoding and HashiCorp Vault for secure key management, ensuring the tokens are both interoperable and protected. In the sequence, it executes Platform Agnostic Token Created (522), producing a token that embeds metadata detailing App A's (500) failing network function—say, authentication—along with its specific features, such as endpoint URLs or supported identity providers (e.g., Okta), and its communication protocol (e.g., HTTPS with TLS 1.3), adhering to the RFC 7519 JSON Web Token standard while extending it with custom fields like failover priority or routing hints to enhance cross-platform compatibility. This token might be generated on an AWS Lambda function triggered by the token request, encrypted with a 256-bit AES key retrieved from HashiCorp Vault and signed with an RSA signature, ensuring that any backup application, such as App B (502) or App C (504), can securely interpret and act upon it, facilitating a rapid and reliable transition.

The Event Bus (512) orchestrates token distribution and backup coordination, utilizing robust event-driven technologies like Kafka for high-throughput messaging, RabbitMQ for flexible queue management, or Google Pub/Sub for cloud-native scalability, capable of handling thousands of messages per second across a distributed network. The flow includes Token Broadcast: App A Failover (524), where the Gen AI Token Generator (510) broadcasts the token to all backup applications within the ecosystem, followed by Token Distributed for App A Role (526), specifically targeting the set of backups including App B (502) and App C (504) to assume App A's (500) responsibilities, such as processing payment transactions. The sequence advances to Acceptance Signal: App B Ready (528), where App B (502) responds with a readiness signal—indicating, for instance, 60% CPU availability and 16 gigabytes of free memory—processed by the Event Bus (512) to select App B (502) as the first responder, a decision that might be logged in a Redis cache for quick reference, reflecting the system's decentralized, low-latency coordination that completes within milliseconds.

The Gateway (514) manages network traffic routing, employing advanced tools like Envoy Proxy for precise proxying, HAProxy for high-performance load balancing, or Istio for service mesh capabilities, dynamically adjusting traffic flow based on the failover token. In the flow, it performs Policy Update: Route Traffic to App B (530), where it updates its routing policies—potentially via a REST API call modifying YAML configurations—to redirect traffic from App A (500) to App B (502), a process that might initially shift 10% of traffic as a canary test before fully committing, ensuring stability. The sequence concludes with Network Traffic Redirected to App B (532), where the Gateway (514) completes the failover by fully rerouting HTTPS requests—such as payment authorizations—from App A (500) on AWS to App B (502) on Azure, leveraging service discovery tools like Consul to resolve App B's (502) endpoint, achieving a seamless transition with zero downtime, as might occur during an OAuth 2.0 transaction, maintaining user experience and transaction integrity.

This hybrid depiction integrates the architecture—App A (500), App B (502), App C (504), Network Monitoring System (506), AI Model Cluster (508), Gen AI Token Generator (510), Event Bus (512), and Gateway (514)—with a detailed flow from Health Metrics (516) through Failure Detected, App A Down (518), Token Request: App A Policies/Features (520), Platform Agnostic Token Created (522), Token Broadcast: App A Failover (524), Token Distributed for App A Role (526), Acceptance Signal: App B Ready (528), Policy Update: Route Traffic to App B (530), and Network Traffic Redirected to App B (532), showcasing the invention's innovative approach to network resiliency. The system's ability to monitor, detect, generate, distribute, and redirect—supported by AI-driven tokenization and event-driven coordination—ensures robust, scalable, and secure failover, adaptable to diverse platforms and operational demands, as exemplified by the transition from App A (500) to App B (502).

Pseudocode exemplars for implementing various aspects of this disclosure are set forth below with explanations for reference.
// Cluster of AI Models Configuration
Function InitializeAIModelCluster():
   Define model_list=[]
   Define network_functions=[“authentication”, “authorization”, “data_validation”, “traffic_filtering”, “load_balancing”, “encryption_offloading”]

For each function in network_functions:
Define primary_model=LoadModel(“TensorFlow”, function)
Define backup_model=LoadModel(“PyTorch”, function)
   Train primary_model with dataset(function_features, app_capabilities, protocols)
Train backup_model with dataset(function_features, app_capabilities, protocols)
Set primary_model as active
Set backup_model as passive
Add (primary_model, backup_model) to model_list
Deploy model_list in cluster with redundancy_check()
Return model_list

### // Network Monitoring System

Function MonitorNetwork():
Define monitoring_tools={“Prometheus”: “metrics”, “Grafana”: “visualization”, “ELK”: “logs”}
Define app_thresholds=LoadThresholdConfig()
Define app_health={}
While true:
   For each app in ecosystem:
      Define metrics=CollectMetrics(app, monitoring_tools[“Prometheus”])
      Define logs=AggregateLogs(app, monitoring_tools[“ELK”])
      Update app_health[app]=AnalyzeHealth(metrics, logs)
      If app_health[app] <app_thresholds[app]:
         Trigger AIClusterResponse(app, app_health[app])
   Sleep(monitoring_interval)

### // Generative AI Token Creation

Function GenerateToken(network_function, app_features, protocol):
Define token_schema={“standard”: “RFC7519”, “custom_fields”: [“app_features”, “protocol”, “encryption_key”]}
Define ai_model=SelectModel(network_function, InitializeAIModelCluster())
Define token_data=ai_model.Predict(app_features, protocol)
Define token=PyJWT.Encode(token_data, token_schema)
Define encryption_key=HashiCorpVault.GenerateKey()
Sign token with encryption_key
Encrypt token with encryption_key
Store token in HashiCorpVault
Return token

### // Event Bus for Token Distribution

Function DistributeToken(token, network_function):
Define event_bus=InitializeEventBus(“Kafka”)
Define backup_apps=SubscribeApps(event_bus)
Broadcast token to backup_apps via event_bus
Define acceptance_signals=[]
While timeout not reached:
   Define signal=ReceiveSignal(event_bus)
   If signal indicates readiness for network_function:
      Add signal to acceptance_signals
Define selected_app=SelectFirstResponder(acceptance_signals)
If selected_app exists:
   ConfirmAssignment(selected_app, token)
Return selected_app

### Dynamic Gateway Policy Update

Function UpdateGatewayPolicy(selected_app, token):
Define gateway=LoadGatewayConfig(“EnvoyProxy”)
Define new_policy=ParseToken(token)
Define routing_config={“app”: selected_app, “rules”: new_policy[“rules”]}
   Update gateway.routing_policy with routing_config via API_CallDotUpdate(gateway, routing_config)
RedirectTraffic(selected_app)

### // Main Execution Loop

Function Main():
Define ai_cluster=InitializeAIModelCluster()
Define monitoring_thread=StartThread(MonitorNetwork)
While true:
   Define failed_app=WaitForTrigger(ai_cluster)
   If failed_app exists:
      Define network_function=IdentifyFailedFunction(failed_app)
      Define app_features=GetAppFeatures(failed_app)
      Define protocol=GetProtocol(failed_app)
      Define token=GenerateToken(network_function, app_features, protocol)
      Define selected_app=DistributeToken(token, network_function)
      If selected_app exists:
         UpdateGatewayPolicy(selected_app, token)

The pseudocode provided outlines a sample implementation of a platform-agnostic, AI-driven tokenization system designed to enhance network resiliency, encompassing multiple interconnected components that work together to ensure seamless application failover. The first function, InitializeAIModelCluster, sets up a cluster of artificial intelligence models tailored to handle various network functions, including authentication, authorization, data validation, traffic filtering, load balancing, and encryption offloading. It iterates through a predefined list of these functions, creating pairs of primary and backup models using TensorFlow and PyTorch frameworks respectively. Each model undergoes training with datasets comprising function-specific features, application capabilities, and communication protocols, establishing an active-passive configuration where the primary model operates while the backup remains on standby. These model pairs are then deployed within a cluster, incorporating a redundancy check to guarantee continuous operation, and the function returns the configured model list for subsequent use.

The MonitorNetwork function establishes a continuous network monitoring system that leverages a suite of tools—Prometheus for metrics collection, Grafana for visualization, and the ELK stack for log aggregation—to oversee application health across the ecosystem. It begins by loading predefined threshold configurations for each application, initializing a dictionary to store health statuses, and entering a perpetual loop. Within this loop, the function collects metrics and aggregates logs for every application, analyzing these inputs to update the health status. If an application's health falls below its specified threshold, the function triggers a response from the AI cluster, passing along the affected application and its health data, before pausing briefly to regulate monitoring frequency.

The GenerateToken function handles the creation of platform-agnostic tokens, a cornerstone of the invention's interoperability. It defines a token schema adhering to the RFC 7519 JSON Web Token standard, augmented with custom fields such as application features, protocol, and encryption key. The function selects an appropriate AI model from the initialized cluster based on the specified network function, using this model to predict token data from the provided application features and protocol. PyJWT encodes this data into a token, which is then signed and encrypted using a key generated and stored via HashiCorp Vault, ensuring security. The completed token is returned for distribution.

The DistributeToken function manages token dissemination through an event-driven architecture utilizing a Kafka-based event bus. It initializes the event bus and identifies subscribed backup applications, broadcasting the token to them. The function then listens for acceptance signals from these applications, collecting responses that indicate readiness to assume the specified network function. Within a set timeout period, it gathers these signals, selects the first responder as the designated backup application, and confirms the assignment if a responder exists, returning the selected application for further processing.

The UpdateGatewayPolicy function automates traffic redirection by updating gateway configurations upon successful token acceptance. It loads the gateway setup using Envoy Proxy, parses the token to extract routing rules, and constructs a new routing configuration specifying the selected application and associated rules. This configuration updates the gateway's routing policy through an API call, effectively redirecting traffic to the new application, ensuring operational continuity without manual intervention.

The Main function orchestrates the entire system, serving as the execution entry point. It initializes the AI model cluster and launches the network monitoring system in a separate thread to run concurrently. Entering an infinite loop, the function awaits triggers from the monitoring system indicating a failed application. Upon detection, it identifies the compromised network function, retrieves the application's features and protocol, and generates a corresponding token. This token is distributed via the event bus, and if a backup application accepts it, the function updates the gateway policy to redirect traffic, completing the failover process.

This pseudocode encapsulates the invention's key features, including the AI model cluster's specialization and redundancy, real-time network monitoring with customizable thresholds, generative AI-driven token creation with a standardized yet flexible schema, event-driven token distribution with decentralized acceptance, and automated gateway updates for seamless traffic management. Each function interlinks to form a cohesive system that adapts to diverse application environments, ensuring resiliency through automation and platform independence.

The implementation reflects the invention's unique aspects, such as the use of federated learning implicitly within the AI models'training to preserve privacy, though not explicitly coded here for simplicity. The pseudocode assumes underlying functions like LoadModel, CollectMetrics, and ParseToken, representing integrations with existing libraries and tools, which someone skilled in the art would recognize as standard practice. The system's scalability is supported through containerized deployment, inferred in the monitoring and gateway components, aligning with modern distributed computing paradigms.

Together, these functions provide an example blueprint for implementing one or more aspects of the inventions disclosed herein, capturing their essence in a structured, procedural form that facilitates understanding and implementation without requiring undue experimentation by those proficient in the field.

The systems and methods described in the disclosure lend themselves to a variety of alternatives, modifications, combinations, and customizations that remain consistent with the underlying principles of enhancing network resiliency through a platform-agnostic, AI-driven tokenization approach. One potential alternative involves the substitution of the artificial intelligence frameworks used in the cluster of models. While TensorFlow and PyTorch serve as the foundational technologies, other frameworks such as MXNet or Keras could be employed to train the models, depending on specific performance requirements or resource constraints. Similarly, the fine-tuned models from OpenAI could be replaced with alternatives like BERT or custom-built models trained on proprietary datasets, offering flexibility in adapting the system to specialized network environments.

The configuration of the AI model cluster itself presents opportunities for modification. Instead of an active-passive setup, a fully active configuration could be implemented where all models operate simultaneously, distributing the workload across multiple nodes to enhance processing speed. Another variation might involve scaling the cluster dynamically based on network demand, adding or removing models as traffic patterns fluctuate. This adaptability ensures the system remains efficient in both small-scale and enterprise-level deployments. Additionally, the training datasets could be customized to include specific application features or protocols unique to a given ecosystem, tailoring the models'predictive capabilities to particular use cases.

The network monitoring system allows for several customizations to suit different operational contexts. While Prometheus, Grafana, and the ELK stack are specified, alternative tools such as Nagios for monitoring, Splunk for log aggregation, or custom-built visualization dashboards could be integrated. The threshold values, currently defined per application type, could be adjusted dynamically using machine learning algorithms that analyze historical performance data to predict optimal trigger points, enhancing the system's proactive nature. Another modification might involve extending monitoring to additional metrics, such as network latency or packet loss, providing a more comprehensive view of ecosystem health.

In the token generation process, alternatives to the PyJWT library and HashiCorp Vault could be considered. For instance, the system could utilize JSON Web Signatures (JWS) with different signing algorithms, such as RSA or ECDSA, depending on security preferences. Token storage might shift to a distributed ledger system like Hyperledger for enhanced transparency and immutability, particularly in environments requiring audit trails. The token schema itself could be customized by adding fields like expiration timestamps or priority levels, allowing finer control over failover prioritization. Furthermore, the generative AI could incorporate reinforcement learning to refine token creation over time, adapting to feedback from successful or failed failovers.

The event bus component offers a range of modifications and combinations. While Kafka, RabbitMQ, and Google Pub/Sub are proposed, other messaging systems like Apache ActiveMQ or AWS SNS/SQS could be substituted based on infrastructure compatibility. A hybrid approach might combine multiple event bus technologies, using one for high-throughput token distribution and another for low-latency signaling, optimizing performance across diverse network conditions. The acceptance signal mechanism could be enhanced by introducing a bidding process where backup applications submit capacity scores, enabling the system to select the most capable responder rather than the first, improving resource allocation.

Dynamic gateway policy updates could be modified by integrating alternative traffic management tools beyond Envoy Proxy, HAProxy, or Istio. For example, NGINX or Traefik could be employed as gateways, each bringing distinct routing capabilities suited to specific traffic types. The update process might be customized to support gradual traffic shifting, where the gateway incrementally redirects requests to the backup application, minimizing disruption during failover. Another variation could involve integrating with software-defined networking (SDN) controllers, allowing broader network reconfiguration beyond individual gateways, enhancing scalability in large deployments.

Combinations across these components are also feasible. The AI model cluster could be paired with a customized monitoring system that feeds real-time metrics directly into model training, creating a closed-loop system where monitoring data refines token generation accuracy. The event bus might be combined with a modified token schema to include application-specific routing hints, streamlining gateway updates by predefining traffic paths. Additionally, the gateway update mechanism could integrate with the monitoring system to validate post-failover performance, triggering rollback procedures if the backup application underperforms, ensuring reliability.

The system's deployment offers further customization options. While containerized microservices are implied, the invention could be adapted for serverless architectures using platforms like AWS Lambda or Google Cloud Functions, reducing overhead in low-traffic scenarios. Alternatively, a bare-metal deployment might be preferred for high-performance environments requiring minimal latency. The choice of cloud versus edge deployment could be hybridized, with monitoring and token generation occurring at the edge for speed, while model training resides in the cloud for computational power, balancing efficiency and responsiveness.

Privacy-preserving techniques, such as federated learning, could be expanded or altered. Differential privacy might be introduced to add noise to training data, further safeguarding sensitive information, or homomorphic encryption could enable token processing without decryption, enhancing security in untrusted environments. These modifications maintain the system's focus on data protection while adapting to regulatory or organizational requirements.

The failover logic itself could be customized to support multi-tiered backups, where tokens are distributed in waves to primary, secondary, and tertiary backup applications, ensuring redundancy if initial responders fail. Another combination might integrate predictive analytics into the monitoring system, preemptively generating tokens for applications nearing their thresholds, reducing reaction time. The system could also be modified to handle multi-function failovers, generating composite tokens that address simultaneous failures in authentication and load balancing, for instance, broadening its scope.

While the present technology has been explained through what are currently regarded as the most practical and preferred embodiments, it should be recognized that these specifics are provided solely for illustrative purposes, and the disclosure is not confined to the particular descriptions and embodiments outlined. Instead, it is intended to encompass modifications and comparable arrangements that fall within the spirit and scope of the appended claims. For instance, it is understood that the present technology envisions the possibility of integrating, where feasible, one or more elements from any given embodiment with one or more elements from any other embodiment. This flexibility ensures that the invention remains adaptable to diverse technical contexts, maintaining its core objective of seamless, resilient network operation across heterogeneous platforms.

1. A method for enhancing network resiliency across a plurality of applications, comprising:
training, by a cluster of artificial intelligence models, each model in the cluster on a distinct network function from a set of network functions including authentication, authorization, data validation, traffic filtering, load balancing, and encryption offloading, wherein each model in the cluster is configured to generate policies based on application features and communication protocols;
monitoring, by a network monitoring system, health metrics of each application in the plurality of applications, wherein the health metrics include processor usage, memory consumption, and error rates;
detecting, by the network monitoring system, when the health metrics of a first application in the plurality of applications fall below a predefined threshold;
generating, by a generative artificial intelligence, a platform-agnostic token for the first application upon detection, wherein the platform-agnostic token includes metadata specifying a network function from the set of network functions, application features of the first application, and a communication protocol;
distributing, by an event bus, the platform-agnostic token to a set of backup applications within the plurality of applications;
receiving, by the event bus, an acceptance signal from a second application in the set of backup applications indicating readiness to perform the network function specified in the platform-agnostic token;
updating, by a gateway, a routing policy to redirect network traffic from the first application to the second application based on the platform-agnostic token; and
redirecting, by the gateway, the network traffic to the second application using the updated routing policy.

2. The method of claim 1, wherein training each model in the cluster of artificial intelligence models includes using a dataset comprising historical application performance data and protocol specifications.

3. The method of claim 2, wherein monitoring the health metrics of each application in the plurality of applications includes aggregating logs using a log aggregation tool and visualizing the health metrics via a graphical interface.

4. The method of claim 3, wherein detecting when the health metrics of the first application fall below the predefined threshold includes comparing the health metrics against a threshold value customized for the first application based on its operational requirements.

5. The method of claim 4, wherein generating the platform-agnostic token includes encrypting the platform-agnostic token with an encryption key stored in a secure vault.

6. The method of claim 5, wherein distributing the platform-agnostic token to the set of backup applications includes broadcasting the platform-agnostic token across a distributed messaging system configured to handle high-throughput communication.

7. The method of claim 6, wherein receiving the acceptance signal from the second application includes selecting the second application as a first responder from multiple acceptance signals received within a predefined timeout period.

8. The method of claim 7, wherein updating the routing policy includes modifying a configuration file of the gateway via an application programming interface call.

9. The method of claim 8, wherein redirecting the network traffic to the second application includes validating the second application's performance post-redirection using the network monitoring system.

10. The method of claim 9, further comprising refining, by the cluster of artificial intelligence models, token generation accuracy using federated learning across the plurality of applications without exposing application-specific data.

11. A method for enhancing network resiliency across a plurality of applications, comprising:
training, by a cluster of artificial intelligence models, each model in the cluster on a distinct network function from a set of network functions including authentication, authorization, data validation, traffic filtering, load balancing, and encryption offloading, wherein each model in the cluster is configured to generate policies based on application features and communication protocols, and wherein training each model in the cluster includes using a dataset comprising historical application performance data and protocol specifications;
monitoring, by a network monitoring system, health metrics of each application in the plurality of applications, wherein the health metrics include processor usage, memory consumption, and error rates, and wherein monitoring the health metrics includes aggregating logs using a log aggregation tool and visualizing the health metrics via a graphical interface;
detecting, by the network monitoring system, when the health metrics of a first application in the plurality of applications fall below a predefined threshold, wherein detecting includes comparing the health metrics against a threshold value customized for the first application based on its operational requirements;
generating, by a generative artificial intelligence, a platform-agnostic token for the first application upon detection, wherein the platform-agnostic token includes metadata specifying a network function from the set of network functions, application features of the first application, and a communication protocol, and wherein generating the platform-agnostic token includes encrypting the platform-agnostic token with an encryption key stored in a secure vault;
distributing, by an event bus, the platform-agnostic token to a set of backup applications within the plurality of applications, wherein distributing includes broadcasting the platform-agnostic token across a distributed messaging system configured to handle high-throughput communication;
receiving, by the event bus, an acceptance signal from a second application in the set of backup applications indicating readiness to perform the network function specified in the platform-agnostic token, wherein receiving the acceptance signal includes selecting the second application as a first responder from multiple acceptance signals received within a predefined timeout period;
updating, by a gateway, a routing policy to redirect network traffic from the first application to the second application based on the platform-agnostic token, wherein updating the routing policy includes modifying a configuration file of the gateway via an application programming interface call;
redirecting, by the gateway, the network traffic to the second application using the updated routing policy, wherein redirecting includes validating the second application's performance post-redirection using the network monitoring system;
refining, by the cluster of artificial intelligence models, token generation accuracy using federated learning across the plurality of applications without exposing application-specific data;
deploying, by a container orchestration platform, the cluster of artificial intelligence models, the network monitoring system, the event bus, and the gateway as microservices across edge and cloud environments;
adjusting, by the network monitoring system, the predefined threshold dynamically based on real-time network conditions; and
generating, by the generative artificial intelligence, a composite token addressing multiple network functions when the health metrics indicate simultaneous degradation across more than one network function of the first application.

12. A system for enhancing network resiliency across a plurality of applications, comprising:
a cluster of artificial intelligence models configured to train each model in the cluster on a distinct network function from a set of network functions including authentication, authorization, data validation, traffic filtering, load balancing, and encryption offloading, wherein each model in the cluster is configured to generate policies based on application features and communication protocols;
a network monitoring system configured to monitor health metrics of each application in the plurality of applications, wherein the health metrics include processor usage, memory consumption, and error rates, and to detect when the health metrics of a first application in the plurality of applications fall below a predefined threshold;
a generative artificial intelligence configured to generate a platform-agnostic token for the first application upon detection by the network monitoring system, wherein the platform-agnostic token includes metadata specifying a network function from the set of network functions, application features of the first application, and a communication protocol;
an event bus configured to distribute the platform-agnostic token to a set of backup applications within the plurality of applications and to receive an acceptance signal from a second application in the set of backup applications indicating readiness to perform the network function specified in the platform-agnostic token; and
a gateway configured to update a routing policy to redirect network traffic from the first application to the second application based on the platform-agnostic token and to redirect the network traffic to the second application using the updated routing policy.

13. The system of claim 12, wherein the cluster of artificial intelligence models is further configured to train each model using a dataset comprising historical application performance data and protocol specifications.

14. The system of claim 13, wherein the network monitoring system is further configured to aggregate logs using a log aggregation tool and to visualize the health metrics via a graphical interface.

15. The system of claim 14, wherein the network monitoring system is further configured to compare the health metrics against a threshold value customized for the first application based on its operational requirements to detect when the health metrics fall below the predefined threshold.

16. The system of claim 15, wherein the generative artificial intelligence is further configured to encrypt the platform-agnostic token with an encryption key stored in a secure vault.

17. The system of claim 16, wherein the event bus is further configured to broadcast the platform-agnostic token across a distributed messaging system designed to handle high-throughput communication.

18. The system of claim 17, wherein the event bus is further configured to select the second application as a first responder from multiple acceptance signals received within a predefined timeout period.

19. The system of claim 18, wherein the gateway is further configured to modify a configuration file via an application programming interface call to update the routing policy.

20. The system of claim 19, wherein:
the cluster of artificial intelligence models is further configured to operate in an active-passive setup where each model in the cluster has a corresponding backup model ready to assume operations if a primary model fails, and to refine token generation accuracy using federated learning across the plurality of applications without exposing application-specific data;
the network monitoring system is further configured to validate the second application's performance post-redirection by analyzing updated health metrics including latency and throughput after the network traffic is redirected, and to adjust the predefined threshold dynamically based on real-time network conditions observed across the plurality of applications;
the generative artificial intelligence is further configured to generate a composite token addressing multiple network functions when the health metrics indicate simultaneous degradation across more than one network function of the first application, wherein the composite token includes additional metadata specifying each affected network function;
the event bus is further configured to prioritize distribution of the platform-agnostic token to the set of backup applications based on their current operational capacity; and
the gateway is further configured to integrate with a container orchestration platform to deploy the system as microservices across edge and cloud environments, ensuring scalability and responsiveness during traffic redirection.
